(19) United States
(12) Patent Application Publication
(10) Pub. No.: US 2008/0115739 A1
(43) Pub. Date: May 22, 2008

(54) JINGLE-LESS PET COLLAR

(76) Inventor: Linda Clenney, Collinsville, IL (US)

Correspondence Address: SPENCER FANE BRITT & BROWNE LLP, 1 NORTH BRENTWOOD BLVD., SUITE 1000, ST. LOUIS, MO, 63105-3925, US

(21) Appl. No.: 11/941,313

(22) Filed: Nov. 16, 2007

Related U.S. Application Data
(60) Provisional application No. 60/860,777, filed on Nov. 22, 2006.

(51) Int. Cl. A01K 27/00

(52) U.S. Cl. 119/863

(57) ABSTRACT

A pet collar suitable for use with dogs, cats, or other quadrupeds having a plurality of loops or D-rings to which tags may be attached, wherein the loops or D-rings are spaced apart a sufficient distance along the collar to prevent contact by one tag with another tag thus providing a jingle-less collar.

### CROSS REFERENCE TO ELATED APPLICATIONS

This application is related to earlier-filed Provisional Application Ser. No. 60/860,777, filed Nov. 22, 2006. The identified earlier-filed application is hereby incorporated by reference into the present application.

### BACKGROUND OF THE INVENTION

Pet collars for tethering and leading animals, especially dogs, are well known to those skilled in the art. Known pet collars are available in a variety of configurations, typically consisting of a leather or nylon webbing strap, connecting means for fastening the collar around the animal's neck, and a loop or D-ring for attachment of a leash or tether.

The known pet collars have a single metal loop or D-ring to which the tether or leash and all necessary and desirable tags are connected. Thus, when two or more registration, identification, and vaccination tags are connected to the metal loop or D-ring, the tags will collide with each other when the pet moves causing a jingling noise which many people find objectionable.

Accordingly, it is desirable to provide a pet collar that includes multiple points for attachment of the leash and necessary tags and where the points of attachment are sufficiently remote to avoid the jingling noise.

### BRIEF SUMMARY OF THE INVENTION

There is therefore provided in the practice of the invention an improved pet collar suitable for use with dogs, cats, or other pets having a plurality of loops or D-rings to which registration, identification, and vaccination tags may be separately attached. It is an object of the present invention to provide an improved pet collar whereby the jingling tag noise will be substantially eliminated. This is achieved by the addition of one or more additional loops or D-rings which are spaced apart a sufficient distance along the collar to prevent contact by one tag with another tag thus providing a jingle-less collar.

In an embodiment of the invention a collar for tethering and leading animals, especially dogs, is provided, comprising a strap, connecting means for fastening the collar around the pet's neck, and a plurality of loops or D-rings, for fastening a leash or tether, and for attaching multiple tags separated to avoid contact of any tag with any other tag.

In accordance with one embodiment of the present invention, the collar includes three D-rings. The D-rings being spaced apart, to allow up to three tags to move without the constant jingling noise that results from a single D-ring collar.

In accordance with another embodiment of the invention, the pet collar comprises a nylon strap, a quick-locking side release clasp for fastening the collar around the pet's neck, and at least three D-rings for connection of a tether or leash and tags.

Accordingly, it is an object of the present invention to provide an improved pet collar that substantially eliminates the jingling noise caused by tags colliding together when the pet moves. There has thus been outlined, rather broadly, certain embodiments of the invention in order that the detailed description thereof may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

### BRIEF DESCRIPTION OF THE DRAWINGS

Further features of the present invention will become apparent to those skilled in the at to which the present invention relates from reading the following description with reference to the accompanying drawings, in which:

FIG. 1 is a top perspective view illustrating a pet collar according to an embodiment of the invention.

FIG. 2 is a top view in accordance with one embodiment of the invention.

FIG. 3 is a bottom view in accordance with one embodiment of the invention.

FIG. 4 illustrates a side view in accordance with one embodiment of the invention.

FIG. 5 illustrates an inverted side view in accordance with one embodiment of the invention.

FIG. 6 is a top perspective view illustrating a pet collar according to another embodiment of the invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not been maintained in the Figures. Instead, the sizes of certain small components have been exaggerated for illustration.

An embodiment in accordance with the present invention provides a pet collar suitable for use with dogs, cats, or other pets including a plurality of loops or D-rings to which tags may be attached, and whereby the loops or D-rings are secured to and spaced apart a sufficient distance along the collar to prevent contact by one tag with another tag thus providing a substantially jingle-less collar.

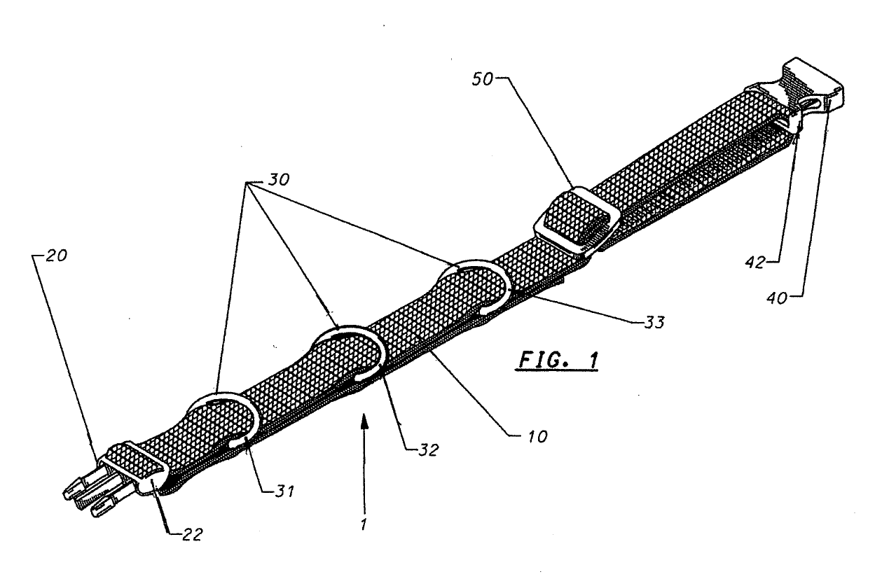

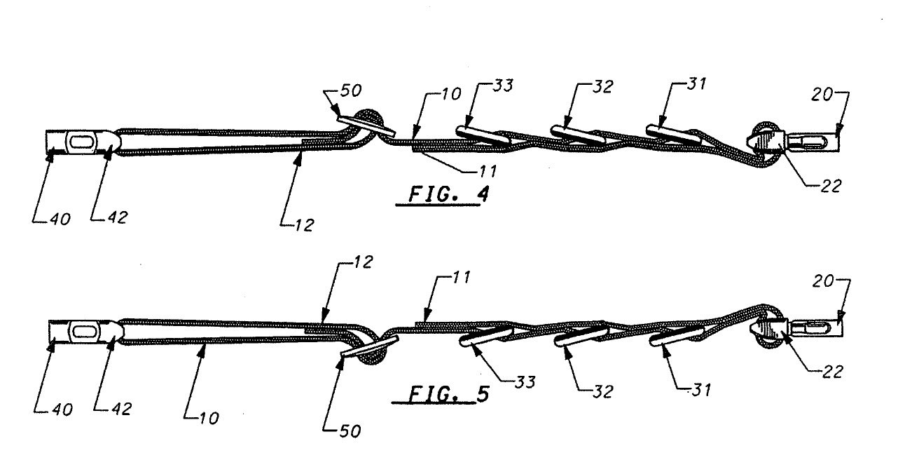

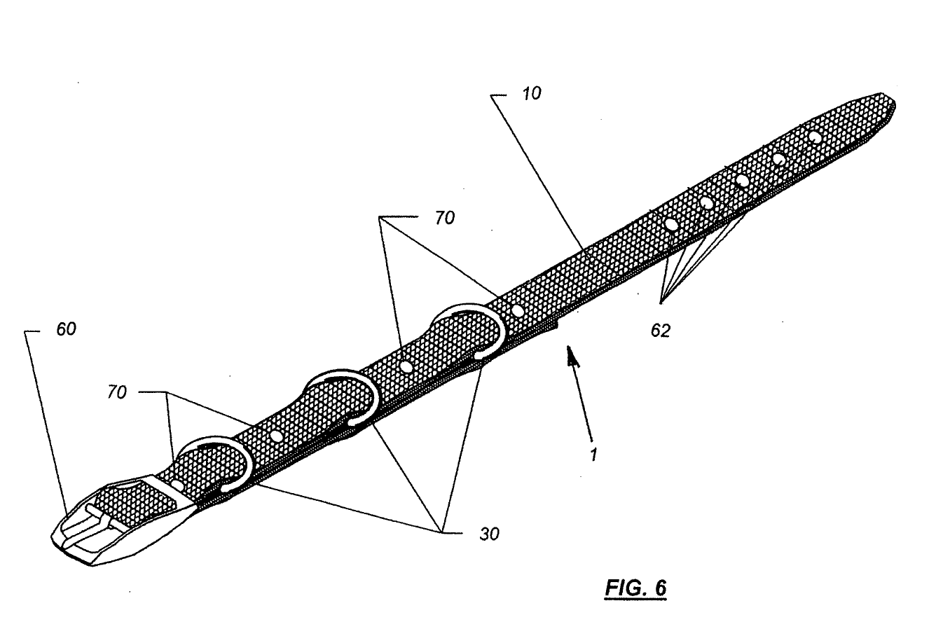

An embodiment of a pet collar of the invention is illustrated in FIG. 1. In this embodiment, pet collar 1, comprising strap 10, male end of side release clasp 20, three loops or D-rings 30, female end of side release clasp 40, and adjustment slide 50, whereby a first end 11 of strap 10 is passed through loops or D-rings 30, and retention means 22 of clasp 20, then strap 10 is folded back on its self and is stitched to retain clasp 20 in a fixed position. The doubled over strap 10 is then further stitched to retain first loop or D-ring 31, and further stitched to retain second loop or D-ring 32 at a sufficient distance from loop or D-ring 31 to avoid contact of a tag suspended from loop or D-ring 31 with a tag suspended from loop or D-ring 32; and further stitched to retain third loop or D-ring 33 at a sufficient distance from loop or D-ring 32 to avoid contact of a tag suspended from loop or D-ring 32 with a tag suspended from loop or D-ring 33, all as more particularly shown in FIG. 4 and FIG. 5.

An embodiment of the invention includes at least three D-rings 30, wherein the three D-rings are metal D-rings, or the three D-rings are molded plastic D-rings. In an alternative embodiment, D-ring 31 is a metal D-ring, while D-ring 32 and D-ring 33 are molded plastic D-rings. It will be appreciated that other configurations including two or more types of loops or D-rings are within the scope of the invention.

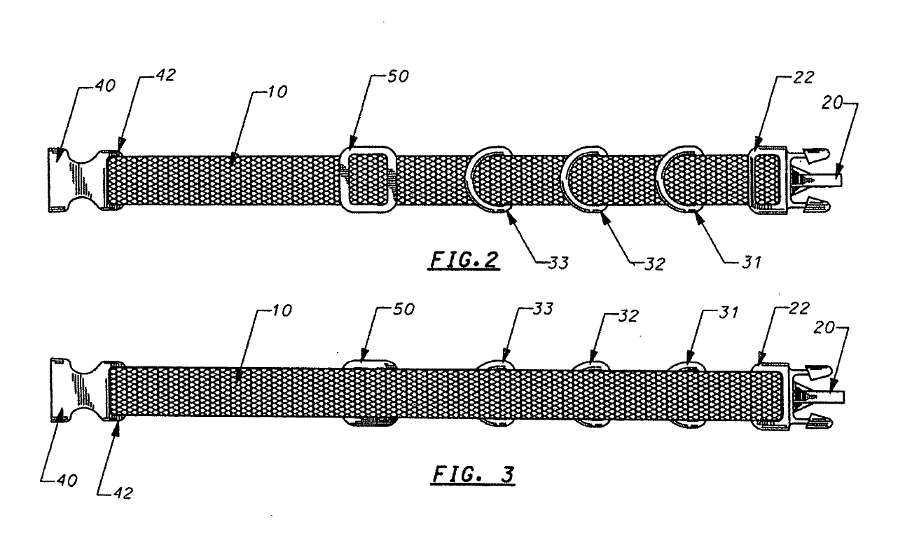

In an embodiment as shown in FIG. 1, the second end 12 of strap 10 is passed through retention means 42 of clasp 40 and adjustment slide 50 whereby the length of the pet collar 10 may be adjusted for proper fit for the pet. Strap 10 may be of any suitable material including leather, nylon, and polyester, capable of being adapted to retain clasp 20 and D-rings 31, 32, and 33 in fixed positions remote from each other as shown in FIG. 2 and FIG. 3, while allowing length adjustment through adjustment slide 50, all as more particularly shown in FIG. 4 and FIG. 5.

The two-component side release clasp assembly having a male end 20 and a female end 40 may be made from any material having suitable flexibility to allow ease of joining and release. In an embodiment, the two-component side release clasp assembly is a molded plastic material.

In another embodiment of the invention, as shown in FIG. 6, strap 10 comprises a fixed length fully stitched, or riveted 70, strap with two or more loops or D-rings 30, and having a buckle 60 of the type well known in the art at one end and including a plurality of perforations 62 spaced along the other end of the strap for adjustable length engagement with the buckle.

The principal object of the invention is to provide a pet collar having a plurality of loops or D-rings spaced along the length of the collar for retaining a plurality of tags in a manner that will substantially eliminate the jingling of the tags when the pet is moving about. Although an example of the pet collar of the invention is shown using three D-rings 30 for engagement of tags, it will be appreciated that other configurations can be used, including any configuration having at least two loops or D-rings. From the above description of embodiments of the invention, those skilled in the art will perceive improvements, changes and modifications. Such improvements, changes and modifications within the skill of the art are intended to be covered by the appended claims.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

I claim:

1. An improved pet collar comprising:
(a) a strap;
(b) connecting elements attached to each end of the strap capable of secure engagement of the strap around the pet's neck;
(c) a plurality of loops attached to the strap, for fastening a leash or tether, and for attaching tags; and
(d) wherein the loops are separated from each other to avoid contact between tags attached to the loops.

2. The pet collar according to claim 1 wherein the strap is nylon.

3. The pet collar according to claim 1 wherein the strap is leather.

4. The pet collar according to claim 1 wherein the connecting elements comprise a two-component side release clasp assembly to securely fasten the collar around the pet's neck.

5. The pet collar according to claim 1 wherein the connecting elements comprise a buckle attached to one end of the strap, and a plurality of perforations spaced along the other end of the strap; whereby the buckle is capable of engagement with the perforations to securely fasten the collar around the pet's neck.

6. The pet collar according to claim 1 including three loops.

7. The pet collar according to claim 6 wherein the loops are separated from each other by approximately 1 inch to approximately 2 inches.

8. The pet collar according to claim 7 wherein the loops are D-rings.

9. The pet collar according to claim 7 wherein at least one loop is a metal loop.
